(19) United States
(12) Patent Application Publication
(10) Pub. No.: US 2012/0120011 A1
(43) Pub. Date: May 17, 2012

(54) TOUCH DISPLAY APPARATUS

(75) Inventors: Chih-Jung Teng, Taichung City (TW); Chin-Chang Liu, Taichung County (TW)

(73) Assignees: WINTEK CORPORATION, Taichung City (TW); Dongguan Masstop Liquid Crystal Display Co., Ltd., Guangdong Province (CN)

(21) Appl. No.: 13/293,126

(22) Filed: Nov. 10, 2011

(30) Foreign Application Priority Data
Nov. 11, 2010 (TW) 99138885

(51) Int. Cl. G06F 3/041

(52) U.S. Cl. 345/173

(57) ABSTRACT

A touch display apparatus including a display panel, a touch panel, an insulation element, and a shielding electrode layer is provided. The touch panel disposed on the display panel includes a substrate, first sensing series, and second sensing series. The insulation element is disposed between the touch panel and the display panel. The shielding electrode layer is disposed between the insulation element and the display panel and includes shielding electrode stripes. Each first sensing series includes first sensing electrodes orthogonally projected on the display panel in a first area. Each second sensing series includes second sensing electrodes orthogonally projected on the display panel in a second area. The first area is separated from an adjacent second area in a distance. Each shielding electrode stripe is orthogonally projected on the display panel in a third area with a width at least identical to the distance.

### CROSS-REFERENCE TO RELATED APPLICATION

This application claims the priority benefit of Taiwan application serial no. 99138885, filed on Nov. 11, 2010. The entirety of the above-mentioned patent application is hereby incorporated by reference herein and made a part of this specification.

### BACKGROUND OF THE INVENTION

1. Field of the Invention

The invention relates to a display apparatus, and more particularly, to a touch display apparatus.

2. Description of Related Art

FIG. 1 is a schematic top view showing a portion of a conventional capacitive touch panel. Referring to FIG. 1, a capacitive touch panel 100 includes a plurality of first sensing series 120 and a plurality of second sensing series 130, wherein the first sensing series 120 and the second sensing series 130 are respectively consisted of a plurality of first sensing electrodes 122 and a plurality of second sensing electrodes 132. A predetermined space G is formed between the first sensing electrodes 122 and the second electrodes 132, which facilitates in generating a corresponding sensing capacitance to accomplish the touch sensing function. In addition, at least one inter-insulation layer (not marked) is disposed between the first sensing series 120 and the second sensing series 130 for an electrical insulation. That is to say, the inter-insulation layer is exposed at where the space G is located.

However, such design may cause the visual effect provided by the capacitive touch panel 100 unsatisfactory. Specifically, when the light passes an interface between different materials, the physical effects such as refraction, reflection, transmission, and the like may be caused, wherein the physical effects are varied with the properties of the materials. In the capacitive touch panel 100, the light would pass through the first sensing electrode 122 and the inter-insulation layer at the position X, the light would pass through the second sensing electrode 132 and the inter-insulation layer at the position Y, and the light would only pass through the inter-insulation layer at the position Z (that is, where the space G is located). The sensing electrodes and the inter-insulation layer have different physical properties such as refractivity, etc. Therefore, uneven brightness is felt by human eyes when the capacitive touch panel 100 is watched. Particularly, the outline of the first sensing electrodes 122 and the second sensing electrodes 132 may be observed.

When the touch panel 100 is combined with a display panel, the worse display quality resulted from the signal interference between the display panel and the touch panel 100 may occur.

### SUMMARY OF THE INVENTION

The invention is directed to a touch display apparatus, wherein an uneven visual effect can be prevented and the signal interference between a touch panel and a display panel is significantly eliminated.

The invention provides a touch display apparatus including a display panel, a touch panel, an insulation element, and a shielding electrode layer. The touch panel includes a substrate, a plurality of first sensing series and a plurality of second sensing series. The first sensing series are disposed on the display panel. The substrate is disposed on the display panel and the first sensing series are disposed on the substrate. Each of the first sensing series extends along a first direction and includes a plurality of first sensing electrodes. The second sensing series are disposed between the first sensing series and the display panel. Each of the second sensing series extends along a second direction to intersect with the first sensing series and includes a plurality of second sensing electrodes. Each of the first sensing electrodes is orthogonally projected on the display panel in a first area, each of the second sensing electrodes is orthogonally projected on the display panel in a second area, and the first area is separated from an adjacent second area in a distance. The insulation element is disposed between the second sensing series and the display panel. The shielding electrode layer is disposed between the insulation element and the display panel. The shielding electrode layer includes a plurality of shielding electrode stripes, wherein each of the shielding electrode stripes is orthogonally projected on the display in a third area with a width identical to the distance.

In view of the above, a patterned shielding electrode layer is disposed between the touch panel and the display panel according to the touch display apparatus of the invention. Therefore, when the patterned shielding electrode layer and the sensing electrodes of the touch panel are made of the same material, the disposition of the patterned shielding electrode layer is not only conducive to eliminate the problems such as the signal interference and the electrostatic discharge, but also conducive to provide an even visual effect.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view showing a portion of a conventional capacitive touch panel.

FIG. 2 illustrates an exploded view showing a portion of a touch display apparatus according to an embodiment of the invention, wherein each element is represented in a plane manner.

FIG. 3 illustrates a schematic top view showing orthogonal projections of the touch sensing series and the shielding electrode layer on a display panel according to a touch display apparatus of an embodiment of the invention.

FIG. 4 illustrates a schematic top view showing a shielding electrode layer according to an embodiment of the invention.

FIG. 5 and FIG. 6 illustrate schematic top views showing the shielding electrode layer according to another embodiments of the invention.

FIG. 7 illustrates a first cross-sectional design of the touch panel and the shielding electrode layer in the touch display apparatus of FIG. 2.

FIG. 8 illustrates a second cross-sectional design of the touch panel and the shielding electrode layer in the touch display apparatus of FIG. 2.

FIG. 9 illustrates a third cross-sectional design of the touch panel and the shielding electrode layer in the touch display apparatus of FIG. 2.

FIG. 10 illustrates a fourth cross-sectional design of the touch panel and the shielding electrode layer in the touch display apparatus of FIG. 2.

FIG. 11 illustrates a fifth cross-sectional design of the touch panel and the shielding electrode layer in the touch display apparatus of FIG. 2.

### DESCRIPTION OF EMBODIMENTS

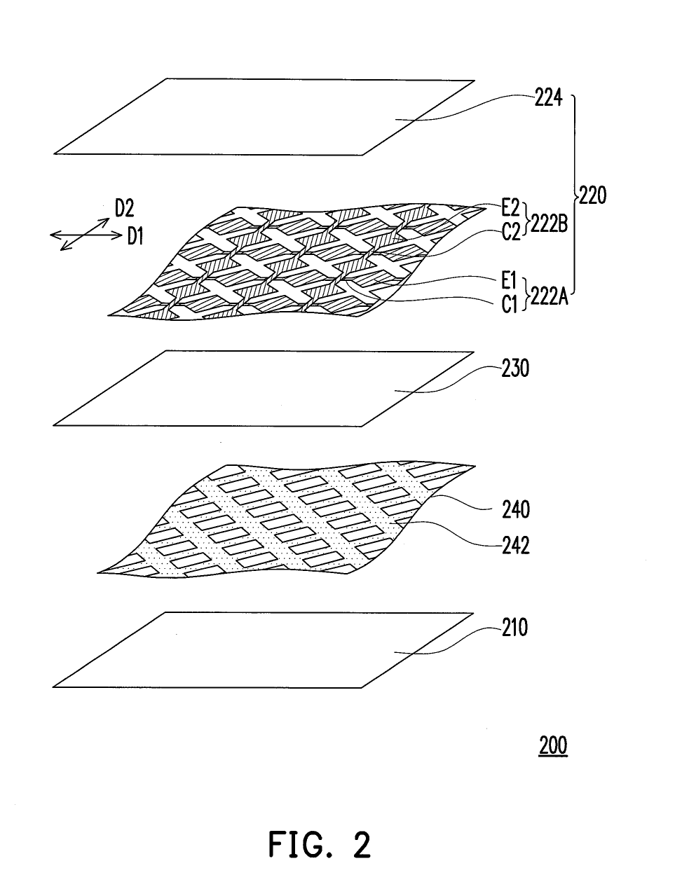

FIG. 2 illustrates an exploded view showing a portion of a touch display apparatus according to an embodiment of the invention, wherein each element is represented in a plane manner. Referring to FIG. 2, a touch display apparatus 200 sequentially includes a display panel 210, a shielding electrode layer 240, an insulation element 230, and a touch panel 220. The type of the display panel 210 includes but not limited in a liquid crystal display, an organic light-emitting diode display, an electro-wetting display, a bi-stable display, and an electrophoretic display.

In the present embodiment, the touch panel 220 is, for example, a projected capacitive touch panel. Namely, the touch panel 200 at least includes a substrate 224, a plurality of first sensing series 222A respectively extended along a first direction D1 and a plurality of second sensing series 222B respectively extended along a second direction D2. The substrate 224 is disposed on the display panel 210, which is, for example, a cover plate, a glass, or a plastic substrate. The first sensing series 222A and the second sensing series 222B are disposed on the substrate 224. In addition, the cover plate comprises a decoration layer and a base substrate wherein the decoration layer is located at a side of base substrate adjacent to the display panel 210 or away from the display panel 210. The material of the decoration layer includes diamond-like carbon, ceramic, colored ink, resin, photo resist or the combination thereof.

Each of the first sensing series 222A includes a plurality of first sensing electrodes E1 and a plurality of first connecting lines C1 serially connecting the first sensing electrodes E1 in the first direction D1. Each of the second sensing series 222B includes a plurality of second sensing electrodes E2 and a plurality of second connecting lines C2 serially connecting the second sensing electrodes E2 in the second direction D2. The sensing electrodes may have a regular shape such as a diamond, a triangle or a line segment or may have an irregular shape. For accomplishing the capacitive touch sensing function, each of the first sensing electrodes E1 is configured to be separated from the adjacent second sensing electrodes E2. In addition, the first sensing series 222A and the second sensing series 222B are electrically independent from each other.

The shielding electrode layer 240 includes a plurality of shielding electrode stripes 242. The configuration of the shielding electrode layer 240 is conducive to prevent from the signal interference problem between the touch panel 220 and the display panel 210. In one embodiment, the shielding electrode layer 240 can be connected to a fixed voltage, a grounding voltage, or a high resistance to provide the signal-shielding effect. Certainly, the shielding electrode layer 240 can further provide the electrostatic discharge (ESD) protection effect. That is to say, an improper accumulation of electrostatic charges in the display panel 210 or the touch panel 220 can be eliminated by draining the electrostatic charges through the shielding electrode layer 240.

In addition, in the present embodiment, the material of the shielding electrode strips 242, the material of the first sensing electrodes E1, and the material of the second sensing electrodes E2 are the same, such as a transparent conductive material. Therefore, the pattern design of the shielding electrode layer 240 can further provide a specific optical compensation effect to prevent from the uneven visual effect resulted from the disposition of the touch panel 220.

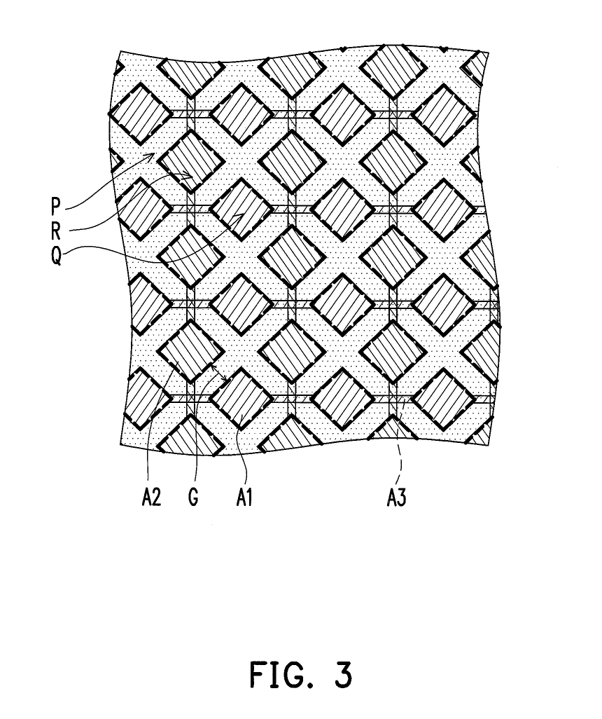

FIG. 3 illustrates a schematic top view showing orthogonal projections of touch sensing series and a shielding electrode layer on a display panel according to a touch display apparatus of an embodiment of the invention. Referring to FIG. 2 and FIG. 3 together, a first area A1 is obtained when the first sensing electrode E1 of the first sensing series 222A in the touch panel 220 is orthogonally projected on the display panel 210 and a second area A2 is obtained when the second sensing electrode E2 of the second sensing series 222B is orthogonally projected on the display panel 210. In addition, each shielding electrode stripe 242 is orthogonally projected on the display panel 210 to obtain a third area A3.

As shown in FIG. 3, the first area A1 is separated from the second area A2 with a distance G and the third area A3 (the board dash lines in FIG. 3 define the boundary of the third area A3 and the scattered points in FIG. 3 define the distribution of the third area A3) is at least filled the space of the distance G in the present embodiment. That is to say, the width of the third area A3 is at least identical to the distance G. Specifically, in addition to the configuration that the width of the third area A3 is just identical to the distance G, the third area A3 can further be partially overlapped with the first area A1 or the second area A2. Certainly, the third area A3 can be simultaneously overlapped with the first area A1 and the second area A2. Accordingly, the width of the third area A3 can be slightly larger than the distance G.

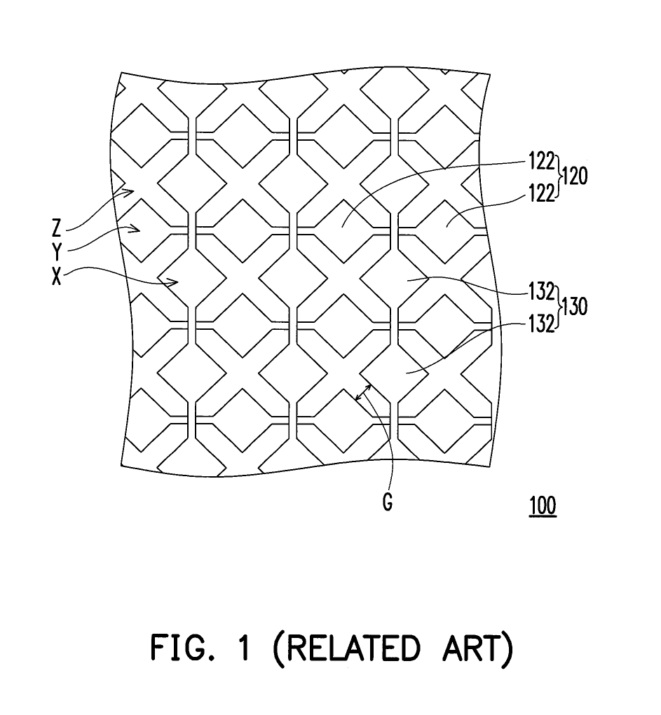

The display light emitted from the display panel 210 passes through one of the shielding electrode stripes 242 and then is received by human eyes at the position P. The display light emitted from the display panel 210 passes through one of the first sensing electrodes E1 and then is received by human eyes at the position Q while the display light emitted from the display panel 210 passes through one of the second sensing electrodes E2 and then is received by human eyes at the position R. Owing that the first sensing electrodes E1, the second sensing electrodes E2, and the shielding electrode stripes 242 are made of the same material, the optical effects such as refraction, reflection, and the like caused by the display light passing through the elements are substantially the same. Therefore, the touch display apparatus 200 can have much even visual effect. Particularly, when it is compared with the conventional design illustrated in FIG. 1, the outlines of the first sensing electrodes E1 and the second sensing electrodes E2 are difficulty observed by a user.

As a whole, the design of the shielding electrode layer 240 is conducive to mitigate the issues such as the signal interference and the ESD in the touch display apparatus 200 and improve the display quality of the touch display apparatus 200. It should be noted that the shielding electrode stripes 242 in the present embodiment constitute a shielding electrode net. Nevertheless, the patterns of the shielding electrode layer 240 can be accomplished by other methods and are not restricted herein.

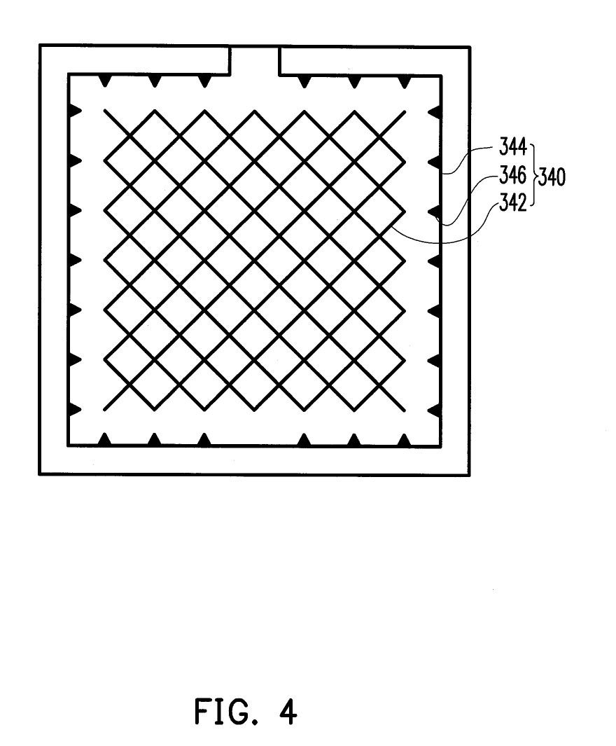

For example, FIG. 4 illustrates a schematic top view showing a shielding electrode layer according to an embodiment of the invention. Referring to FIG. 4, the shielding electrode layer 340 can include a plurality of shielding electrode stripes 342, a shielding electrode ring 344, and a plurality of protrusions 346. The shielding electrode ring 344 substantially surrounds the net pattern formed by the shielding electrode stripes 342 and the protrusions 346 are located on the shielding electrode ring 344. Each of the protrusions 346 has a sharp point (not marked) pointing to a terminal of an adjacent shielding electrode stripe 342. Once an accumulation of electrostatic charges occurred, the shielding electrode stripes 342 can transmit the electrostatic charges and drain the electrostatic charges through the protrusions 346 and the shielding electrode ring 344.

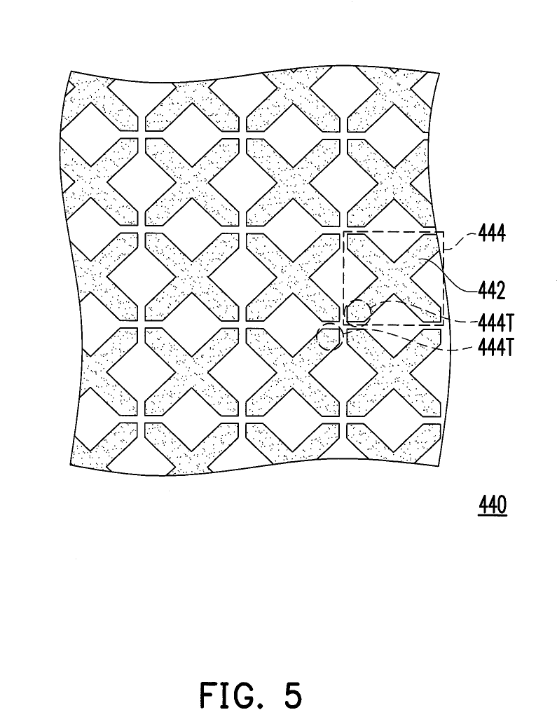

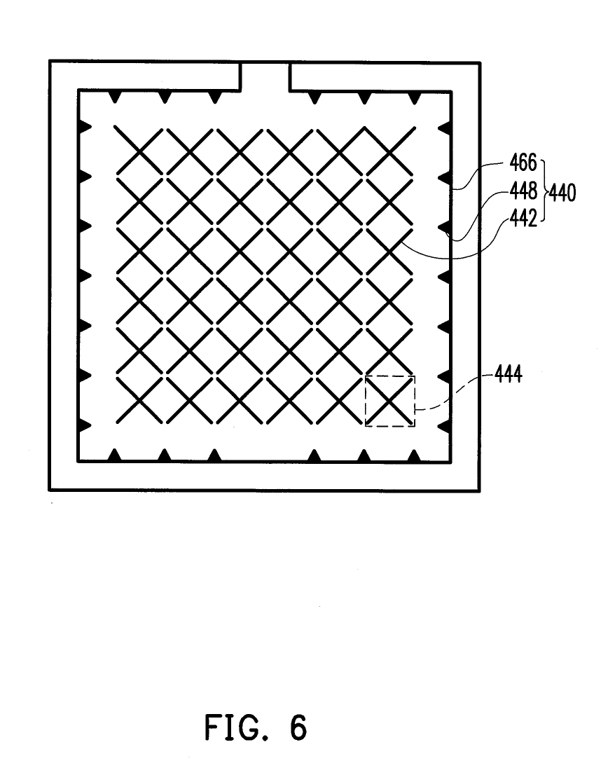

In addition, FIG. 5 and FIG. 6 illustrate schematic top views showing shielding electrode layers according to another embodiments of the invention. Referring to FIG. 5, the shielding electrode layer 440 according to the present embodiment can include a plurality of shielding electrode stripes 442 connecting to constitute a plurality of crossing shielding patterns 444. A terminal 444T of each crossing shielding pattern 444 is pointing to a terminal 444T of another crossing shielding pattern 444. The projection area of each crossing shielding pattern 444 on the display panel 220 can be selectively not overlapped with the first connecting lines C1 of the first sensing series 222A and the second connecting lines C2 of the second sensing series 222B when the shielding electrode layer 440 is applied in the touch display apparatus of FIG. 2. Referring to FIG. 6, the shielding electrode layer 440 can optionally further include a shielding electrode ring 446, and a plurality of protrusions 448. The shielding electrode ring 446 substantially surrounds the crossing shielding patterns 444 and the protrusions 448 are located on the shielding electrode ring 446. It is noted that each of the protrusions 448 has a sharp point (not marked) pointing to a terminal of an adjacent crossing shielding pattern 444.

Based on the aforesaid descriptions, the invention does note specifically limit the pattern design of the shielding electrode layer. It can be adopted in the invention that the orthogonal projection of the shielding electrode layer on the display panel can be completely filled the space between the sensing electrodes, which facilitates desirable optical compensation effect. In addition, the orthogonal projection of the shielding electrode layer on the display panel can be slightly overlapped with the orthogonal projection of the sensing electrodes on the display panel, which further facilitates desirable optical compensation effect at an inclined viewing angle.

Several embodiments illustrating a cross-sectional design of the touch panel and the shielding electrode layer in the touch display apparatus 200 of FIG. 2 are provided in the following. The exemplary embodiments below are only for illustration but not intended to limit the present invention.

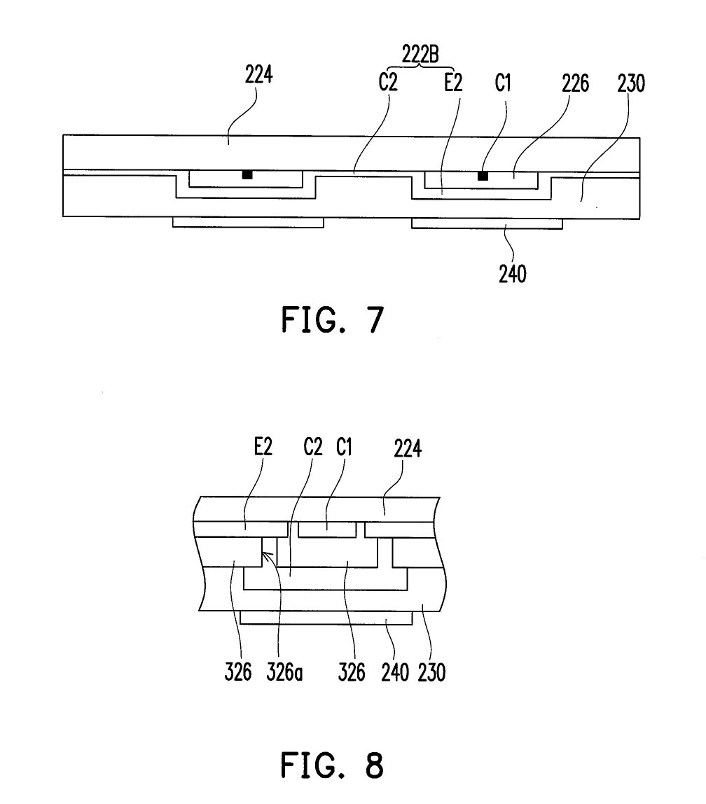

FIG. 7 illustrates a first cross-sectional design of the touch panel and the shielding electrode layer in the touch display apparatus of FIG. 2. Referring to both FIG. 2 and FIG. 7, the touch panel 220 substantially further includes an insulation layer 226 in addition to the substrate 224, the first sensing series 222A and the second sensing series 222B illustrated in FIG. 2. The first connecting lines C1 of the first sensing series 222A is located between the substrate 224 and the insulation layer 226 and the insulation layer 226 is located between the substrate 224 and the second sensing series 222B.

In the present embodiment, the insulation layer 226 is, for instance, consisted of a plurality of island-like insulation patterns and the insulation element 230 is a layer-like insulation element. The disposition location of the shielding electrode layer 240 is at least located between two sensing electrodes. In addition, the first connecting lines C1 and the second connecting lines C2 can be metal or transparent conductive material.

FIG. 8 illustrates a second cross-sectional design of the touch panel and the shielding electrode layer in the touch display apparatus of FIG. 2. Referring to FIG. 8, the design of the touch panel and the shielding electrode layer according to the present embodiment is similar to that in the embodiment of FIG. 7. The difference between the embodiments of FIG. 8 and FIG. 7 lies in that the insulation layer 326 in FIG. 8 further covers the second sensing electrodes E2 in addition to cover the first connecting line C1. In addition, the insulation layer 326 has openings 326a so that the second connecting lines C2 can be electrically connected to the second sensing electrodes E2 through the openings 326a.

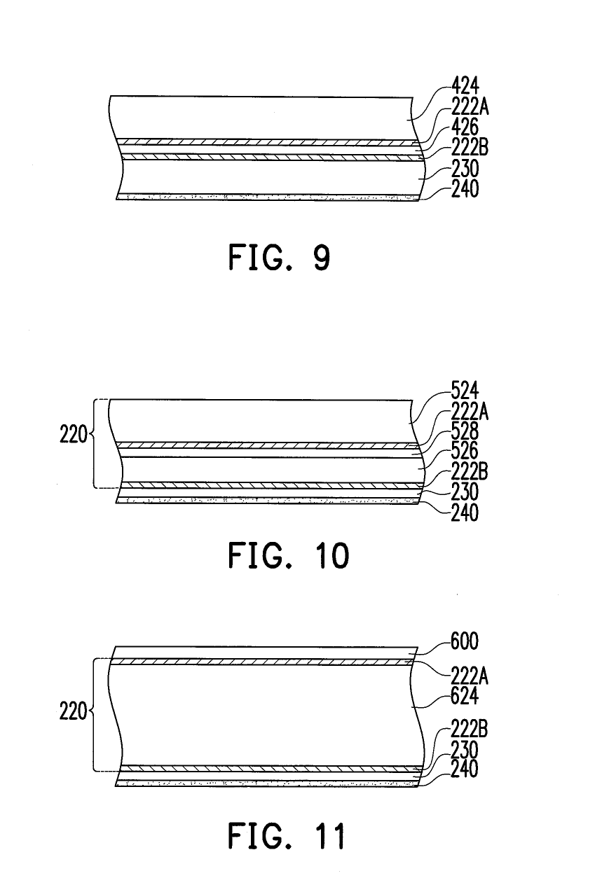

FIG. 9 illustrates a third cross-sectional design of the touch panel and the shielding electrode layer in the touch display apparatus of FIG. 2. Referring to FIG. 2 and FIG. 9 simultaneously, the touch panel 220 further includes a substrate 424 and an insulation layer 426 in addition to the first sensing series 222A and the second sensing series 222B, wherein the first sensing series 222A are located between the substrate 424 and the insulation layer 426 and the insulation layer 426 is located between the substrate 424 and the second sensing series 222B. In the present embodiment, the insulation element 230 is an insulation substrate. Therefore, the second sensing series 222B and the shielding electrode layer 240 can be respectively formed on two opposite sides of the insulation element 230. In other words, the touch panel 220 can be formed by assembling the substrate 424 and the insulation element 230. Herein, the insulation layer 426 can be formed by transparent material such an optical glue or an air layer.

FIG. 10 illustrates a fourth cross-sectional design of the touch panel and the shielding electrode layer in the touch display apparatus of FIG. 2. Referring to FIG. 2 and FIG. 10 together, in the present embodiment, the insulation element 230 is, for example, a layer-like insulation element and is disposed between the touch panel 220 and the shielding electrode layer 240. In addition, the touch panel 220 further includes a substrate 524, a substrate 526, and an insulation layer 528 in addition to the first sensing series 222A and the second sensing series 222B. The first sensing series 222A is fabricated on the substrate 524 and the second sensing series 222B is fabricated on the substrate 526. The insulation layer 528 is disposed between the first sensing series 222A and the substrate 526. The insulation layer 528 and the second sensing series 222B are respectively disposed at two opposite sides of the substrate 526. Herein, the insulation layer 528 can be a transparent insulation layer such an optical glue or an air layer.

FIG. 11 illustrates a fifth cross-sectional design of the touch panel and the shielding electrode layer in the touch display apparatus of FIG. 2. Referring to FIG. 2 and FIG. 11 together, a touch panel 220 includes a plurality of first sensing series 222A, a plurality of second sensing series 222B, and a substrate 624, wherein the first sensing series 222A and the second sensing series 222B are respectively disposed at two opposite sides of the substrate 624. In the present embodiment, the insulation element 230 is, for example, a layer-like insulation element and is disposed between the shielding electrode layer 240 and the second sensing series 222B. In addition, for protecting the first sensing series 222A, a protection layer 600 can be formed on the first sensing series 222A.

In summary, a patterned shielding electrode layer is disposed between the touch panel and the display panel according to the invention. In addition to provide a signal shielding effect and an ESD protection effect, the patterned shielding electrode layer further conduces to mitigate the uneven display quality of the touch display apparatus. Specifically, the shielding electrode layer and the sensing electrodes of the touch panel are made of the same material. The patterns of the shielding electrode layer are disposed in the space between the sensing electrodes according to the invention so that the display light emitted from the display panel can pass through one transparent conductive layer in different positions. Therefore, the touch display apparatus can have much even visual effect.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display apparatus, comprising:
a display panel;
a touch panel, comprising:
a first substrate located above the display panel;
a plurality of first sensing series disposed on the first substrate, each of the first sensing series extending along a first direction and comprising a plurality of first sensing electrodes;
a plurality of second sensing series disposed between the first sensing series and the display panel, each of the second sensing series extending along a second direction to intersect with the first sensing series and comprising a plurality of second sensing electrodes, wherein each of the first sensing electrodes is orthogonally projected on the display panel in a first area, each of the second sensing electrodes is orthogonally projected on the display panel in a second area, and the first area is separated from an adjacent second area in a distance;
a insulation element disposed between the second sensing series and the display panel; and
a shielding electrode layer disposed between the insulation element and the display panel, and comprising a plurality of shielding electrode stripes, wherein each of the shielding electrode stripes is orthogonally projected on the display panel in a third area at least with a width identical to the distance.

2. The touch display apparatus as claimed in claim 1, wherein the third area overlaps with at least one of the first area and the second area.

3. The touch display apparatus as claimed in claim 1, wherein the shielding electrode layer further comprises a shielding electrode ring and a plurality of protrusions, the shielding electrode ring substantially surrounds the shielding electrode stripes, and each of the protrusions is located on the shielding electrode ring and has a sharp point pointing to a terminal of an adjacent shielding electrode stripe.

4. The touch display apparatus as claimed in claim 1, wherein the shielding electrode stripes are connected together to form a shielding electrode net.

5. The touch display apparatus as claimed in claim 1, wherein the shielding electrode stripes comprises a plurality of crossing shielding patterns, and a terminal of each crossing shielding pattern points to a terminal of another crossing shielding pattern.

6. The touch display apparatus as claimed in claim 1, wherein the insulation element is an insulation layer or an insulation substrate.

7. The touch display apparatus as claimed in claim 1, wherein the touch panel further comprises an insulation layer, the first sensing series are located between the first substrate and the insulation layer, and the insulation layer is located between the first substrate and the second sensing series.

8. The touch display apparatus as claimed in claim 7, wherein the touch panel further comprises a second substrate disposed between the insulation layer and the second sensing series, and the insulation layer is an optical glue.

9. The touch display apparatus as claimed in claim 1, wherein the first sensing series and the second series are respectively disposed at two opposite sides of the first substrate.

10. The touch display apparatus as claimed in claim 1, wherein the shielding electrode layer, the first sensing electrodes, and the second sensing electrodes are made of the same material.

11. The touch display apparatus as claimed in claim 1, wherein the first substrate is a glass substrate, a plastic substrate or a cover plate.

12. The touch display apparatus as claimed in claim 11, wherein the cover plate comprises a base substrate and a decoration layer located at a side of the base substrate adjacent to the display panel or away from the display panel.

13. The touch display apparatus as claimed in claim 12, wherein the material of the decoration layer includes diamond-like carbon, ceramic, colored ink, resin, photo resist or the combination thereof.
